(19) United States
(12) Patent Application Publication
(10) Pub. No.: US 2007/0208627 A1
(43) Pub. Date: Sep. 6, 2007

(54) System and method of facilitating group gifts

(76) Inventor: Joseph Abadi, Panama (PA)

Correspondence Address: ETHAN D. CIVAN, 170 SOMERSET DRIVE, BLUE BELL, PA, 19422, US

(21) Appl. No.: 11/365,720

(22) Filed: Mar. 1, 2006

(51) Int. Cl. G06Q 30/00

(52) U.S. Cl. 705/26

(57) ABSTRACT

A method for facilitating group gifts, including prompting a first user to provide registration information, prompting the first user to prompt at least one additional user to provide registration information as a friend of the first user, prompting any users that have provided registration information as friends of each other to identify a group gift, prompting any users that have provided registration information as friends of each other to contribute to a group gift, accumulating any contributions provided by any users for the benefit of the recipient of the group gift, and providing the proceeds of the group gift to the recipient thereof.

### FIELD OF THE INVENTION

The present invention relates to group or pooled gifts.

### BACKGROUND

Gift-giving can enhance and renew friendships. However, desirable gifts tend to be expensive and are therefore often given only to one's closest friends and relatives. Where person to person contact is possible, such as in the office or school settings, group gifts are commonly used to provide attractive gifts to a broader circle of friends. Where person to person contact is not possible, such as in the case of former classmates, former co-workers, or friends who are geographically separated, a method for facilitating group gifts would be useful.

It is also easy to forget to give to give gifts, particularly to persons with whom one does not come into contact on a regular basis. Such persons may be disappointed if they fail to receive gifts from distant friends and relatives. A method for facilitating gift giving under such circumstances would also be useful.

### SUMMARY OF THE INVENTION

A method for facilitating group gifts, including prompting a first user to provide registration information, prompting the first user to prompt at least one additional user to provide registration information as a friend of the first user, prompting any users that have provided registration information as friends of each other to identify a group gift, prompting any users that have provided registration information as friends of each other to contribute to a group gift, accumulating any contributions provided by any users for the benefit of the recipient of the group gift, and providing the proceeds of the group gift to the recipient thereof.

### BRIEF DESCRIPTION OF THE DRAWINGS

FIG. 1 is an illustration of a system in accordance with a first embodiment of the present invention.

FIG. 2 is an illustration of a method in accordance with a first embodiment of the present invention.

FIG. 3 is an illustration of a web page forming a portion of a web site that can be used in implementing a first embodiment of the present invention.

FIG. 4 is an illustration of a web page forming a portion of a web site that can be used in implementing a first embodiment of the present invention.

FIG. 5 is an illustration of a web page forming a portion of a web site that can be used in implementing a first embodiment of the present invention.

FIG. 6 is an illustration of a web page forming a portion of a web site that can be used in implementing a first embodiment of the present invention.

FIG. 7 is an illustration of a web page forming a portion of a web site that can be used in implementing a first embodiment of the present invention.

FIG. 8 is an illustration of a web page forming a portion of a web site that can be used in implementing a first embodiment of the present invention.

FIG. 9 is an illustration of a web page forming a portion of a web site that can be used in implementing a first embodiment of the present invention.

FIG. 10 is an illustration of a web page forming a portion of a web site that can be used in implementing a first embodiment of the present invention.

FIG. 11 is an illustration of a web page forming a portion of a web site that can be used in implementing a first embodiment of the present invention.

FIG. 12 is an illustration of a web page forming a portion of a web site that can be used in implementing a first embodiment of the present invention.

FIG. 13 is an illustration of a web page forming a portion of a web site that can be used in implementing a first embodiment of the present invention.

FIG. 14 is an illustration of a web page forming a portion of a web site that can be used in implementing a first embodiment of the present invention.

FIG. 15A is an illustration of a web page forming a portion of a web site that can be used in implementing a first embodiment of the present invention.

FIG. 15B is an illustration of a web page forming a portion of a web site that can be used in implementing a first embodiment of the present invention.

### DETAILED DESCRIPTION OF THE PREFERRED EMBODIMENTS

The following definitions are provided to aid in construing the claims of the present application:

Circle of Friends: Two or more natural persons or other entities registered as friends of at least one common member of such two or more natural persons or other entities. Thus, in a circle of friends comprising more than two members, each member must be the friend of a common friend of all of the members, but the members may or may not additionally be friends of the remaining members of the circle.

Friend: Any natural person or other entity (1) known to at least one other natural person or other entity and (2) that is a potential gift donor or recipient (or both). For example, without limitation, a friend can be a personal friend, a relative, a current or former co-worker, a current or former classmate, someone sharing an interest, a corporate entity formed to receive contributions for a charitable cause, or a friend of a friend.

Giftpool: A group gift.

Group Gift: A group gift is a gift made by more than one person.

Poolgift: A group gift.

Registered: Any natural person or other entity that has provided registration information.

Registration Information: Information that at a minimum uniquely identifies a user, such as, for example, the user's name and home telephone number or address. Optionally, registration information also includes additional information such as contact information (for contacting the user) and payment information (for completing gifts made by the user).

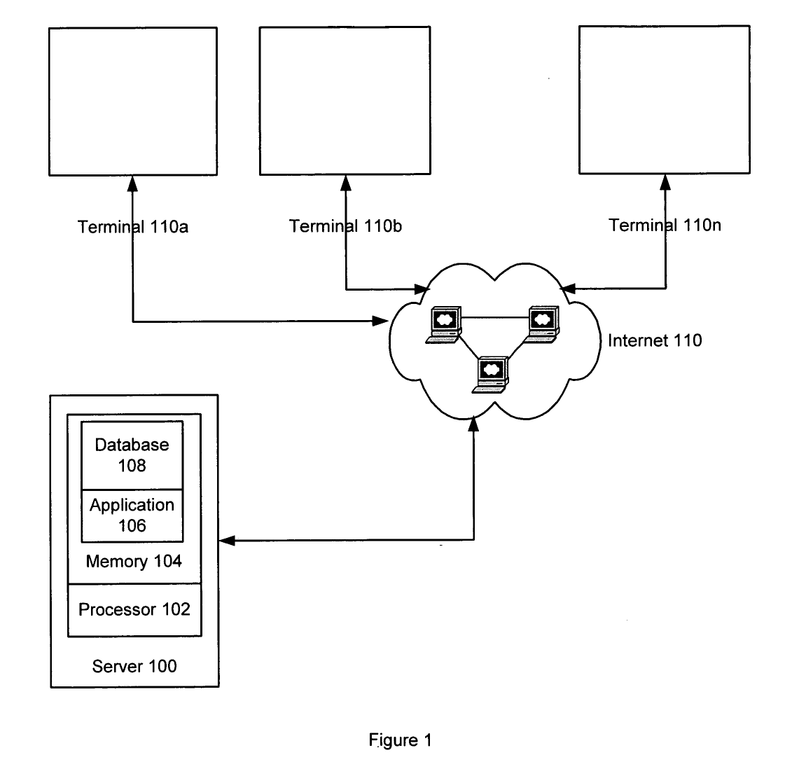

Referring to FIG. 1, in a first preferred embodiment, server 100 includes at least processor 102 and memory 104. Processor 102 can be an Intel Pentium compatible microprocessor, but other types of processors can also be used. Memory 104 can be random access memory (RAM), read only memory (ROM), a hard drive, or other types of memories, although in most cases, a combination of types of memories is utilized, such as both RAM and one or more hard drives. Other components can be present in the server. In the first preferred embodiment a component for communicating with other computers is present, such as a modem or a network interface card allowing server 100 to communicate with a network having an Internet or other connection to other computers. Server 100 can be more than one interconnected computer in order to maximize connection availability with terminals 120a-n. Server 100 can be any Unix, Linux, or Window-based server, such as a Dell PowerEdge 6800 server.

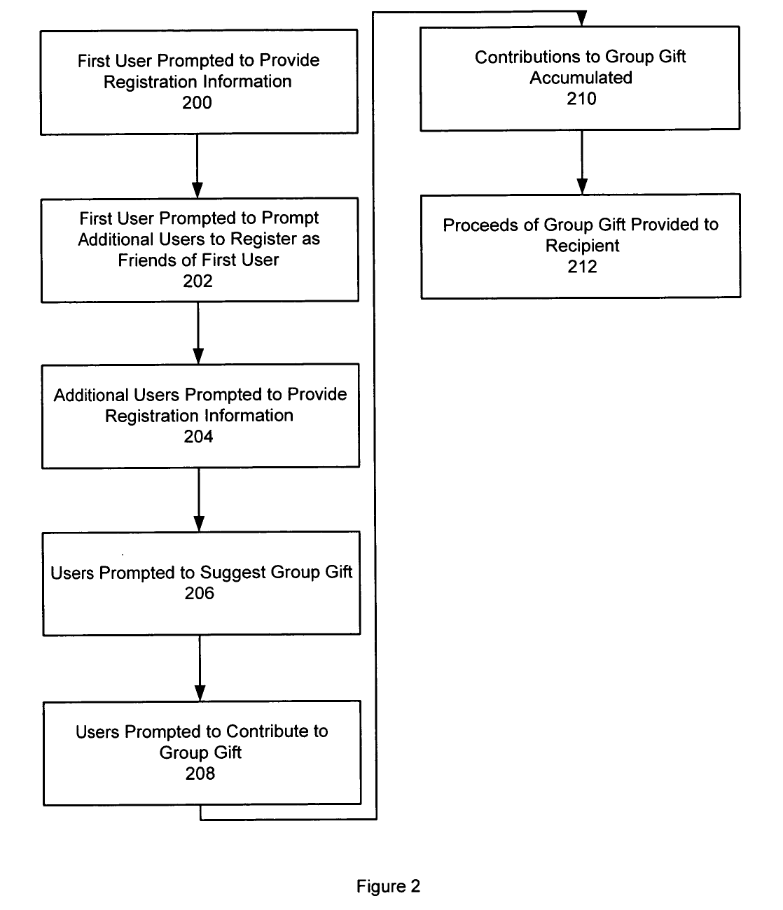

Stored in memory 104 are application 106 and database 108. Application 106 contains code sufficient (in combination with any front end application installed on terminals 120a-n) to carry out the steps of the method described in connection with FIG. 2 below. Database 108 is used to store data relating to such application. Application 106 can be a web-based application and can include a set of web pages, together with functions, macros, or other code that will operate when accessed by a user using a terminal with a standard Internet browser as a front end; however, other formats are also possible. In a first preferred embodiment, application 106 can be written in C# 2.0 ASP.net, for example. Database 108 can be used to store user information, such as user contact and payment information, data relating to lists of friends, data relating to current and past group gifts, data relating to the application itself (such as the options currently available for redeeming gift proceeds), etc. Database 108 can be a relational, object oriented, or other type of database, can be a series of flat files or files in a directory structure, or can be a different type of repository of data. In a first preferred embodiment, database 108 can be Microsoft SQL Server 2000.

Terminals 120a through 120n are connected to server 100 by Internet 110 or by other means (such as by direct modem-to-modem communications or a private network). Each of terminals 120a through 120n is any type of computing device capable of running a front end application capable of communicating with server 100. In a first preferred embodiment, terminals 120a-n can be personal computers, microcomputers, minicomputers, personal digital assistants, smart telephones, and other types of computing devices.

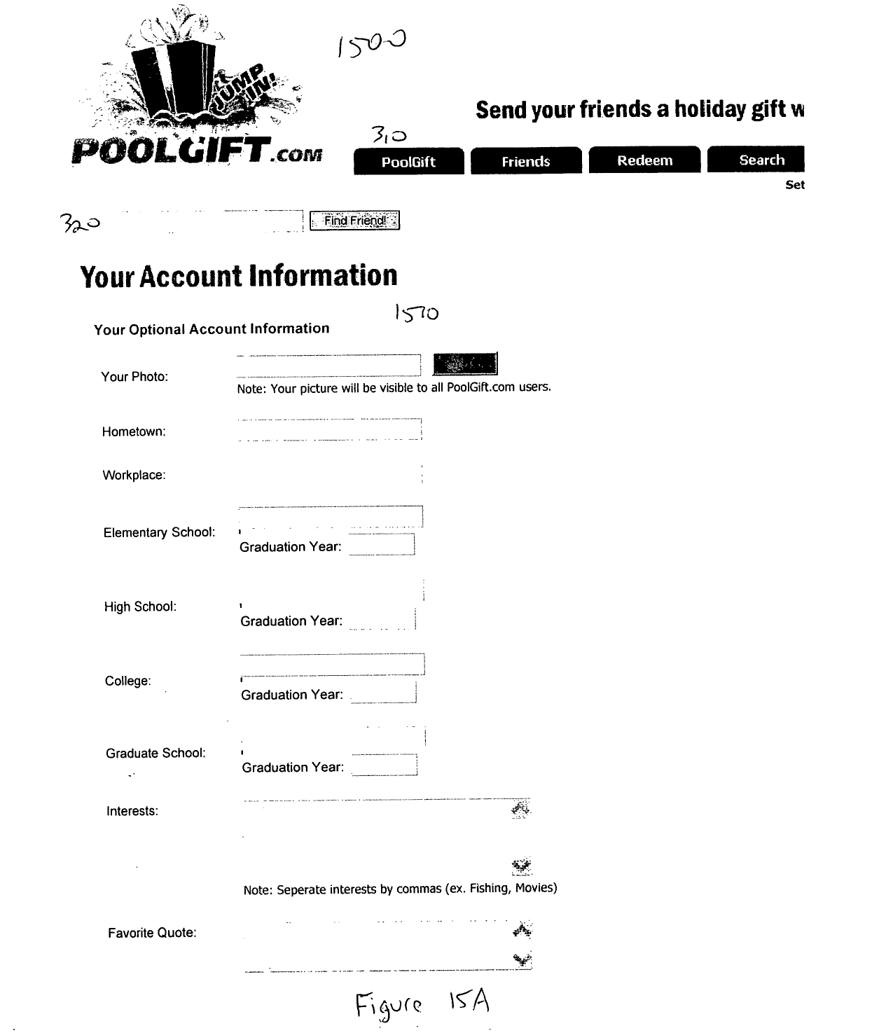

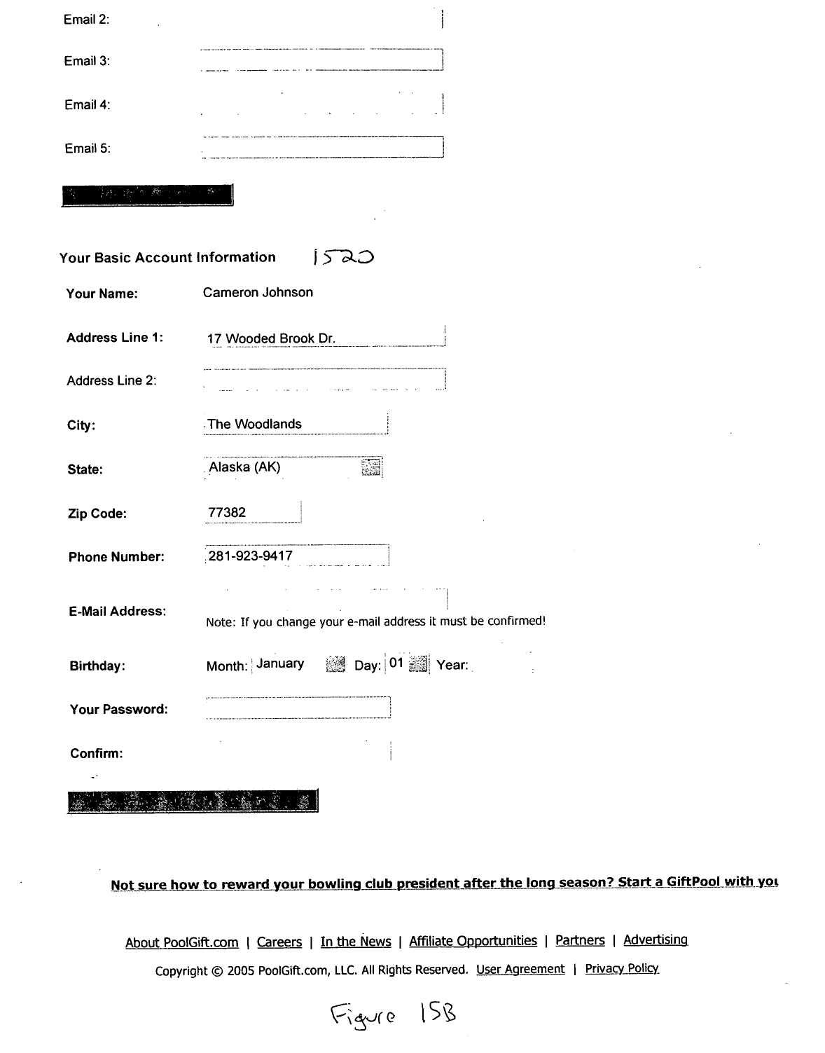

Referring to FIGS. 2 through 15A and 15B, a method in accordance with a first preferred embodiment of the present invention is illustrated. Referring specifically to FIG. 2, in step 200, a first user is prompted to provide registration information. The registration information should include information uniquely identifying the first user, such as the first user's name and home address or telephone number (or social security number). It can also include other information, such as complete contact information, including address, telephone and facsimile numbers, and e-mail addresses. It can also include payment fulfillment information for making gifts, login information for establishing or accessing a user account, and personal information, such as information relating to a user's educational and professional history, information relating to a user's personal interests, and information chosen by the user (such as a favorite quote or a photograph of the user). FIG. 15 illustrates a web page prompting a user to provide registration information.

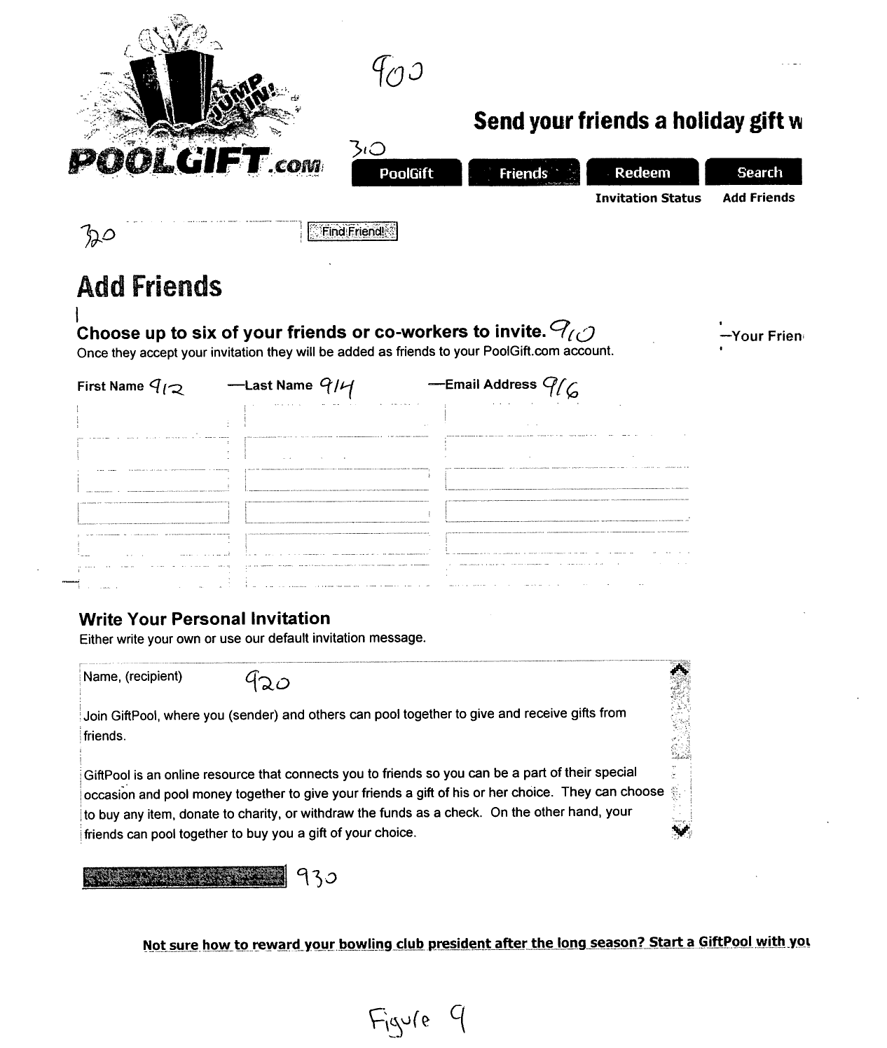

In step 202, the first user is prompted to prompt at least one additional user to provide registration information as a friend of the first user. Preferably, the first user is prompted to prompt as many additional users as possible to provide such registration information. FIG. 9 illustrates a web page prompting a user to prompt additional users to provide such registration information. Each such additional user can be, for example, sent an e-mail message as a result of this step inviting such additional user to register as a friend of the first user. Any such additional user registering as a friend of the first user is then listed as a friend of the first user in a list maintained in database 108. All friends of the first user in a particular circle of friends can view events (such as group gifts) relating to that particular circle of friends. A particular user can be a member of many different circles of friends.

In step 204, additional users are prompted to provide registration information. FIG. 9 illustrates a web page prompting a user to prompt additional users to provide such registration information. In some embodiments of the present invention, any user who has already registered as a friend of the first user can prompt additional users to provide registration information as a friend of the first user. Thus, the circle of friends of the first user can grow exponentially over time. In other embodiments, the user prompting an additional user to provide registration information as a friend of the first user can choose whether to give (or rescind) rights to each such additional user to invite other additional users to provide registration information as a friend of the first user. In such embodiments, a greater degree of control is maintained over the identity of the list of friends by the original friends starting a circle of friends.

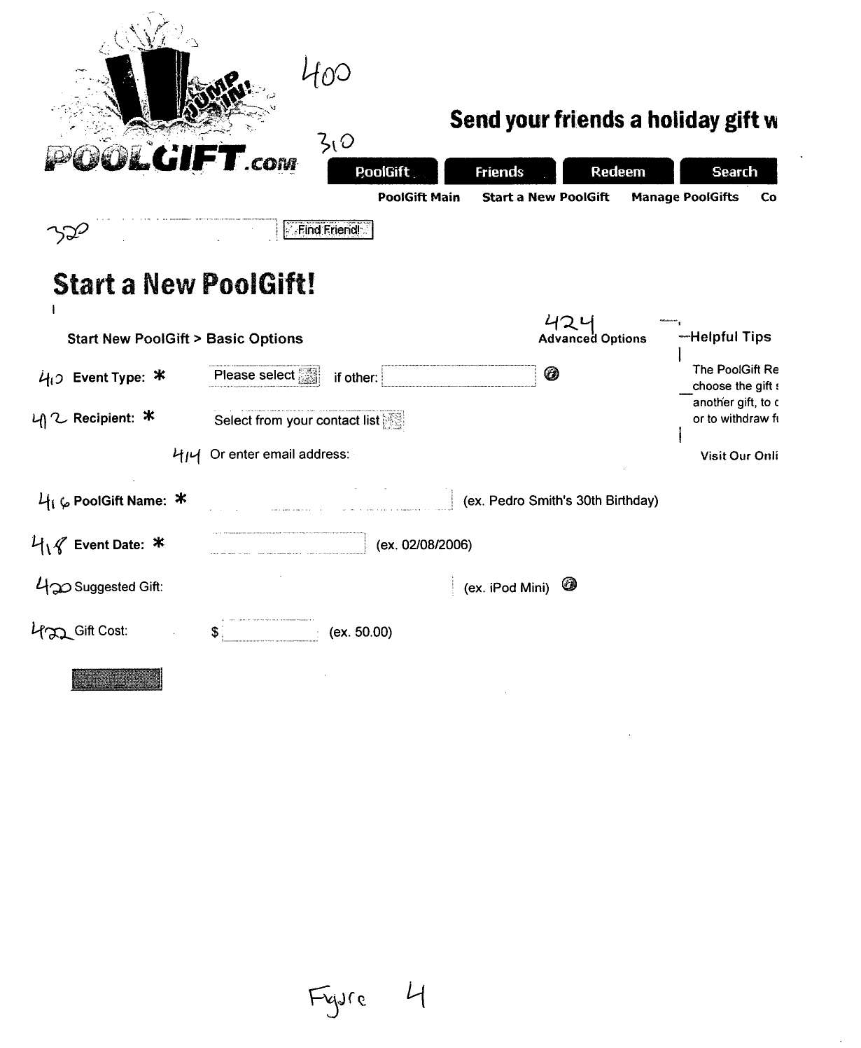

In step 206, one or more of the circle of friends of the first user are prompted to suggest a group gift. FIG. 4 illustrates a web page that can be used to prompt users to suggest a group gift. The recipient of the group gift can be a member of the circle of friends of the first user or can be a person or entity that is not a member of the original circle of friends. In a preferred embodiment, in order to accept a group gift, a person or entity that is not yet a member of the original circle of friends must joint that circle of friends. The gift can be a birthday, anniversary, baby shower, wedding, engagement, Christmas, Hannukah, or other gift. It can also be a charitable gift. In some embodiments of the present invention, the user commencing the group gift can suggest a specific item to be provided to the recipient. In others, cash or gift certificates are provided. In a first preferred embodiment, the recipient is given the option of (1) receiving gift certificates from designated vendors equal to the face amount of the gift, (2) donating the proceeds to a charity of the recipient's choice, or (3) receiving money in the form of a check, Pay Pal credit, or other form of cash transfer in an amount less than the face amount of the gift (the amount being reduced by bank credit fees, handling charges, and the like). The user commencing the group gift can suggest an ending date by which all contributions to the group gift must be made.

In step 208, one or more of the circle of friends of the first user are prompted to contribute to the group gift. In the first preferred embodiment, each member of the circle of friends of the first user is prompted to contribute to the group gift. FIG. 4 illustrates a web page that can be used to prompt users to contribute to a group gift. In a first preferred embodiment, users are given the option to contribute any amount that they choose to each group gift, to disclose or hide the amount contributed to the group gift to the gift recipient, and to add a message to accompany their contributions. Optionally, users can choose to contribute automatically to certain group gifts, such as a set amount to each gift relating to a specified individual or a set amount to each birthday gift relating to a specified individual.

In step 210, all contributions relating to a group gift are accumulated until the ending date is reached for contributing to that group gift. In some embodiments hereunder, such contributions are not maintained in a segregated account, but rather bookkeeping entries are utilized to track the amounts pertaining to such group gift. In some embodiments hereunder, payment is received primarily or exclusively by credit or debit card or other means involving the payment of a fee out of the nominal proceeds of the payment to the payment facilitator (such as the bank providing the credit facilities). Thus, the amount received as a result of the contributions can be less than the amount contributed by the members of the circle of friends participating in the group gift.

In step 212, the proceeds of the group gift are provided to the recipient. Both because the amount received as a result of the contributions can be less than the amount contributed by the members of the circle of friends participating in the group gift and because it is desirable to realize a profit from the operations of the gift pooling service, it can be desirable to provide (a) less than all of the proceeds and (b) to provide proceeds in a form other than in cash. For example, gift certificates can be purchased in bulk at a discount and provided as proceeds at their face amount. Similarly, discount merchandise can be offered at its original value (or at a discount less than the discount actually received for it). In a first preferred embodiment, the user who suggested the group gift can suggest an intended gift, but the recipient receives in any event gift certificates that can be used to purchase that or other gifts. In the first preferred embodiment, the recipient is given the option of (1) receiving gift certificates from designated vendors equal to the face amount of the gift, (2) donating the proceeds to a charity of the recipient's choice, or (3) receiving money in the form of a check, Pay Pal credit, or other form of cash transfer in an amount less than the face amount of the gift (the amount being reduced by bank credit fees, handling charges, and the like).

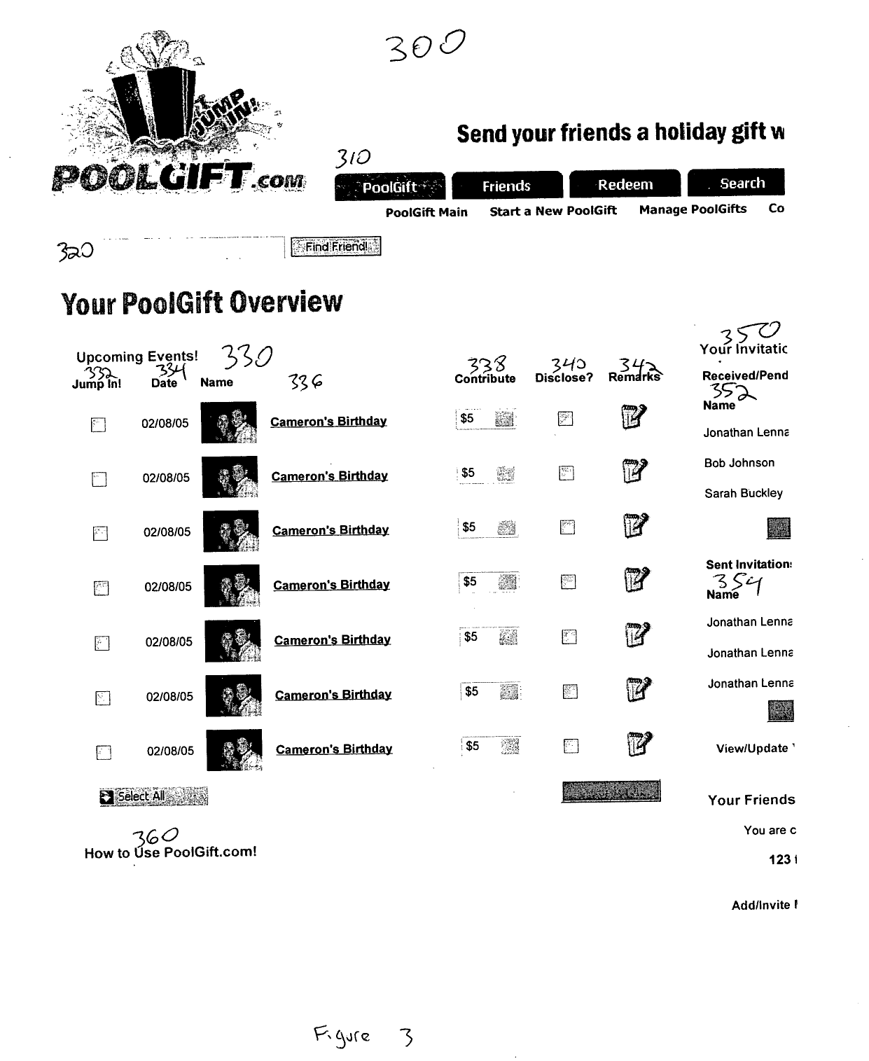

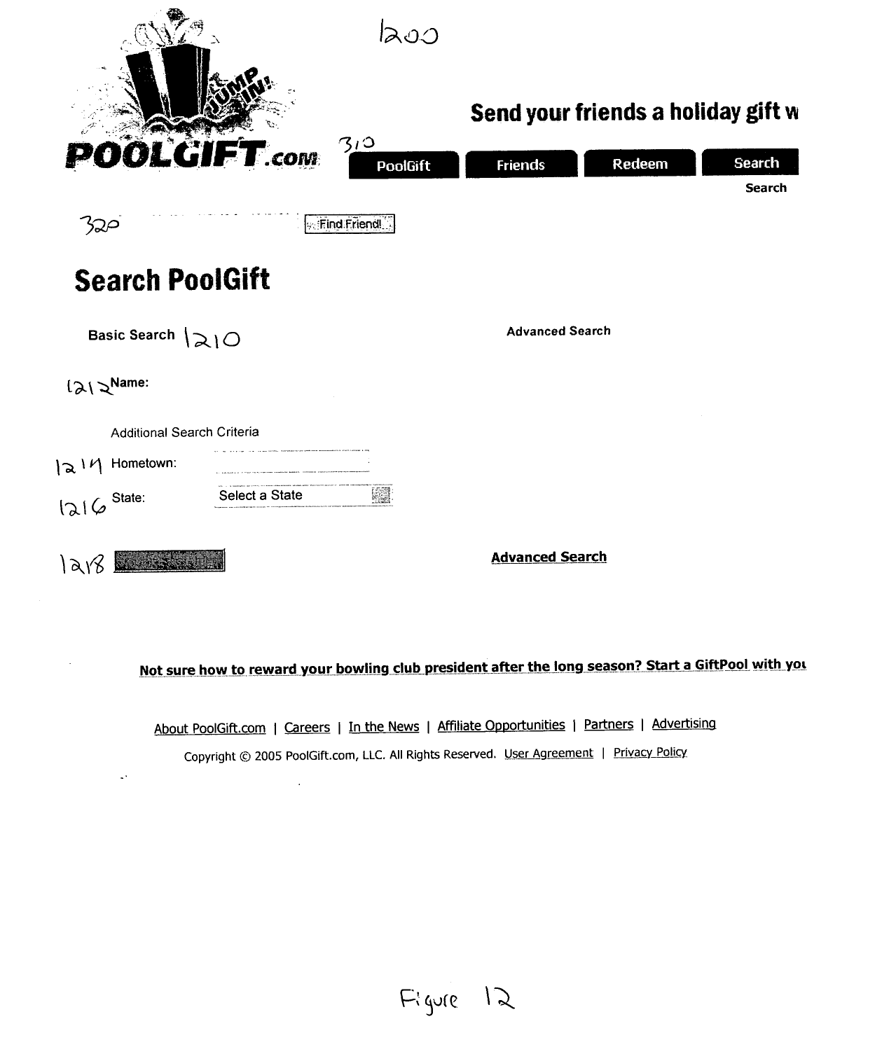

Referring to FIGS. 3 through 15A and 15B, several pages of a web site implementing a method in accordance with a first preferred embodiment of the present invention are illustrated. In FIG. 3, overview page 300 is illustrated. Ordinarily, this web page is displayed only after a user has logged in (such as by providing a user ID and password), thereby verifying his identity. Navigation bar 310 allows users to switch to other pages within the web site. Clicking on a tab on the upper row of the navigation bar (“PoolGift”, “Friends”, “Redeem”, “Search”, and “My Account”), reveals a different set of page choices on the lower row (“PoolGift Main”, “Start a New PoolGift”, “Manage PoolGifts”, etc.). Search area 320 allows a user to type a name into the text box and click on the “Find Friend” button to run a search for a currently registered user. Running such a search will launch the web page illustrated in FIG. 12. Upcoming events list 330 displays group gifts relating to any circle of friends to which the user belongs. The group gifts are listed in a table format, with each group gift forming one row and a number of columns relating to each row. Jump in box 332 is checked if the user is currently scheduled to contribute to the group gift. Otherwise, jump in box 332 can be checked by the user to allow the user to make a contribution to the group gift. Date 334 displays the date by which all contributions must be made to the group gift. Name 336 provides a description of the group gift, such as the name of the recipient and the purpose of the gift (and optionally includes a photograph of the recipient). Contribute box 338 allows the user to choose one of several suggested contribution amounts or type in a different amount. Disclose checkbox 340 allows the user to choose whether the amount contributed will be disclosed to the recipient of the gift when the proceeds are provided to the recipient (the recipient being able to view the identity of the donor but not the amount contributed if the amount contributed is hidden). Remarks checkbox 342, if checked, launches a window into which a message can be typed to the gift recipient to be provided to the gift recipient at the time that the gift proceeds are provided to the gift recipient. Your invitations list 350 includes received/pending invitations 352 and sent invitations 354. Sent invitations 354 are prompts sent by the user to other persons to join a circle of friends of which the user is a member. Received/pending invitations 352 are similar prompts received from other users. Message area 360 contains one or more messages, some or all of which can include hyperlinks leading to other web pages.

Referring to FIG. 4, start new poolgift page 400 is illustrated. Event type drop down list box and text box allows a user to select a type of event for a group gift, such as a birthday or Christmas gift. Drop down list box 412 allows the user to select a recipient of the gift from any circle of friends to which the user belongs. Alternatively, text box 414 allows the user to enter the e-mail address of any recipient, whether or not a member of a circle of friends and whether or not the recipient is registered. Text Box 416 allows the user to designate a name for the group gift. Text box 418 allows the user to enter the date of the gift. Text box 420 allows the user to enter a suggested item for the gift. Text box 422 allows the user to enter a target amount for the group gift. Button 424 allows the user to access an additional page, on which the user can (1) make the gift a surprise to the recipient (by not displaying it to the recipient until the event closes if the recipient is a member of the applicable circle of friends), (2) allow contributions to the group gift a day or a week after the date of the gift, and (3) assign or withdraw rights to other users to invite additional users to contribute to the gift.

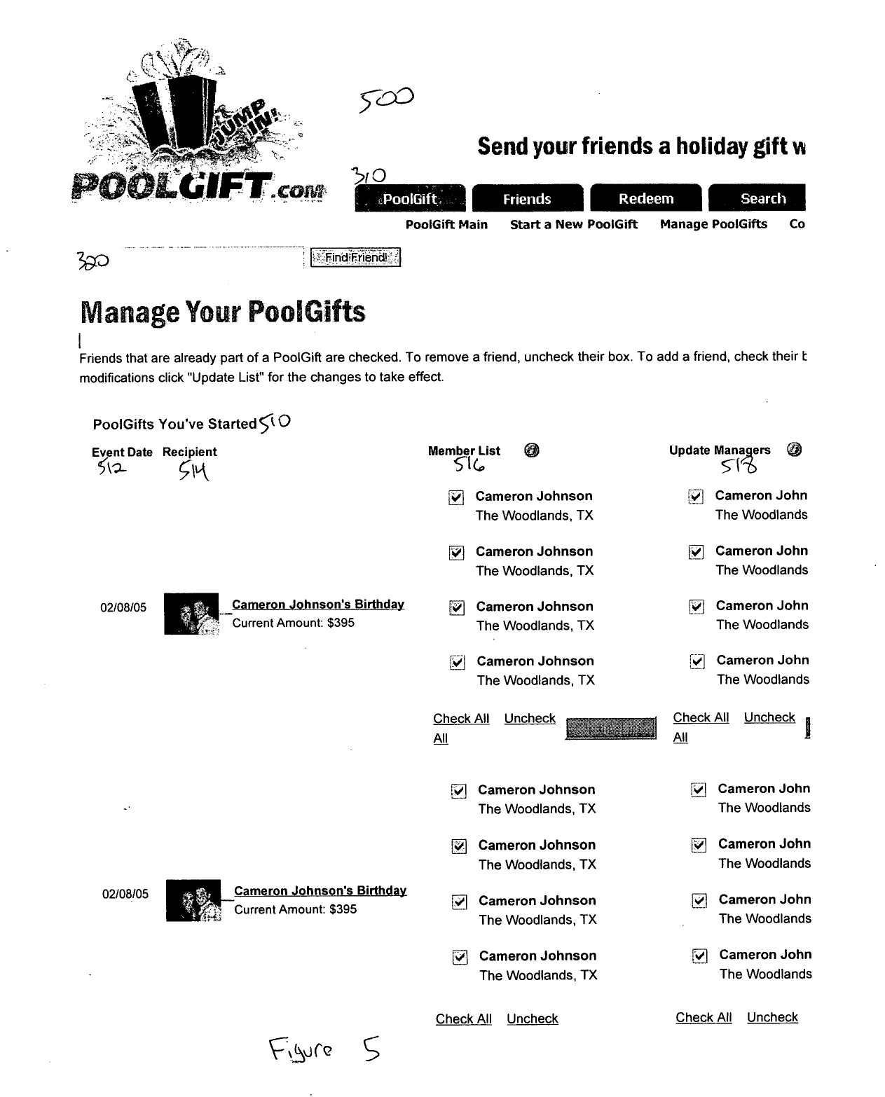

Referring to FIG. 5, manage your poolgifts page 500 is illustrated. Poolgifts are listed in a modified table format (with multiple rows of users being grouped together relating to one group gift) in three sections. Poolgifts commenced by the user are listed in section 510; poolgifts for the user are listed in section 520 (not shown); and poolgifts for which the user has manager rights are listed in section 520 (not shown). The columns are event date 512, which lists the date of the gift, recipient 514, which lists the name of the poolgift, together with the current nominal amount accumulated toward the poolgift, member list 516, which lists each user currently committed to contribute to each poolgift, and update managers, which lists the current rights holder (relating to the right to invite additional users not belonging to the circle of friends to contribute) with respect to each user and permits the user to update the identity of such rights holder if the user has the right to do so.

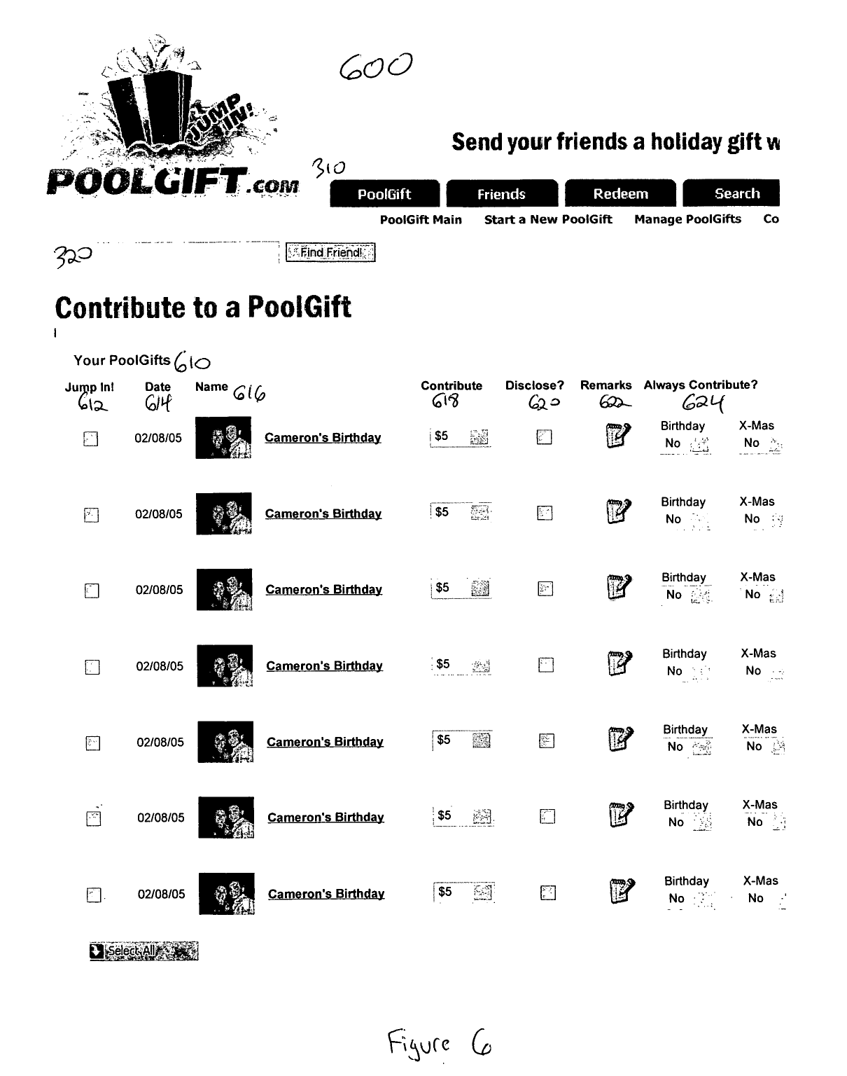

Referring to FIG. 6, contribute to a poolgift page 600 is illustrated. Your poolgifts list 610 displays group gifts relating to any circle of friends to which the user belongs. The group gifts are listed in a table format, with each group gift forming one row and a number of columns relating to each row. Jump in box 612 is checked if the user is currently scheduled to contribute to the group gift. Otherwise, jump in box 612 can be checked by the user to allow the user to make a contribution to the group gift. Date 614 displays the date by which all contributions must be made to the group gift. Name 616 provides a description of the group gift, such as the name of the recipient and the purpose of the gift (and optionally includes a photograph of the recipient). Contribute box 618 allows the user to choose one of several suggested contribution amounts or type in a different amount. Disclose checkbox 620 allows the user to choose whether the amount contributed will be disclosed to the recipient of the gift when the proceeds are provided to the recipient. Remarks checkbox 622, if checked, launches a window into which a message can be typed to the gift recipient to be provided to the gift recipient at the time that the gift proceeds are provided to the gift recipient. Always contribute dropdown boxes 624 allow a user automatically to contribute an amount chosen from a drop down list to all gifts relating to a recipient, all birthday gifts relating to a recipient, or all Christmas gifts relating to a recipient. This frees the user from any need to monitor gifts to that recipient.

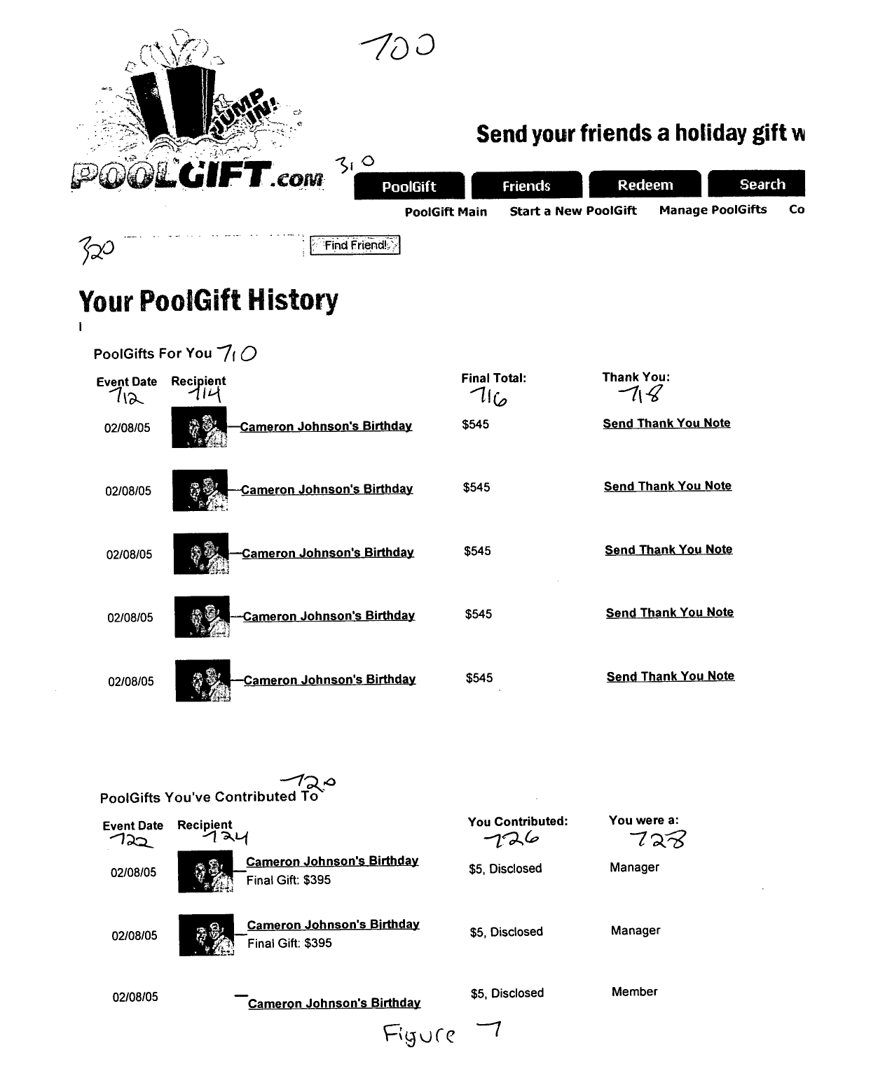

Referring to FIG. 7, poolgift history page 700 is illustrated. Poolgifts for the user are listed in section 710 in table format with one group gift on each row and separate columns for event date 712, the date of the group gift, recipient 714, the descriptive name of the group gift, final total 716, which lists the total amount accumulated in the group gift, and thank you 718, which provides a window for entering text forming a thank you letter to be sent to the contributors of the group gift by e-mail. Poolgifts to which the user has contributed are listed in section 720 in table format with one group gift on each row and separate columns for event date 722, the date of the group gift, recipient 724, the descriptive name of the group gift and also the total amount accumulated in the group gift, amount contributed 726, which lists the amount contributed by the user and whether or not the contribution was disclosed, and manager status 728, which lists whether the user was a manager.

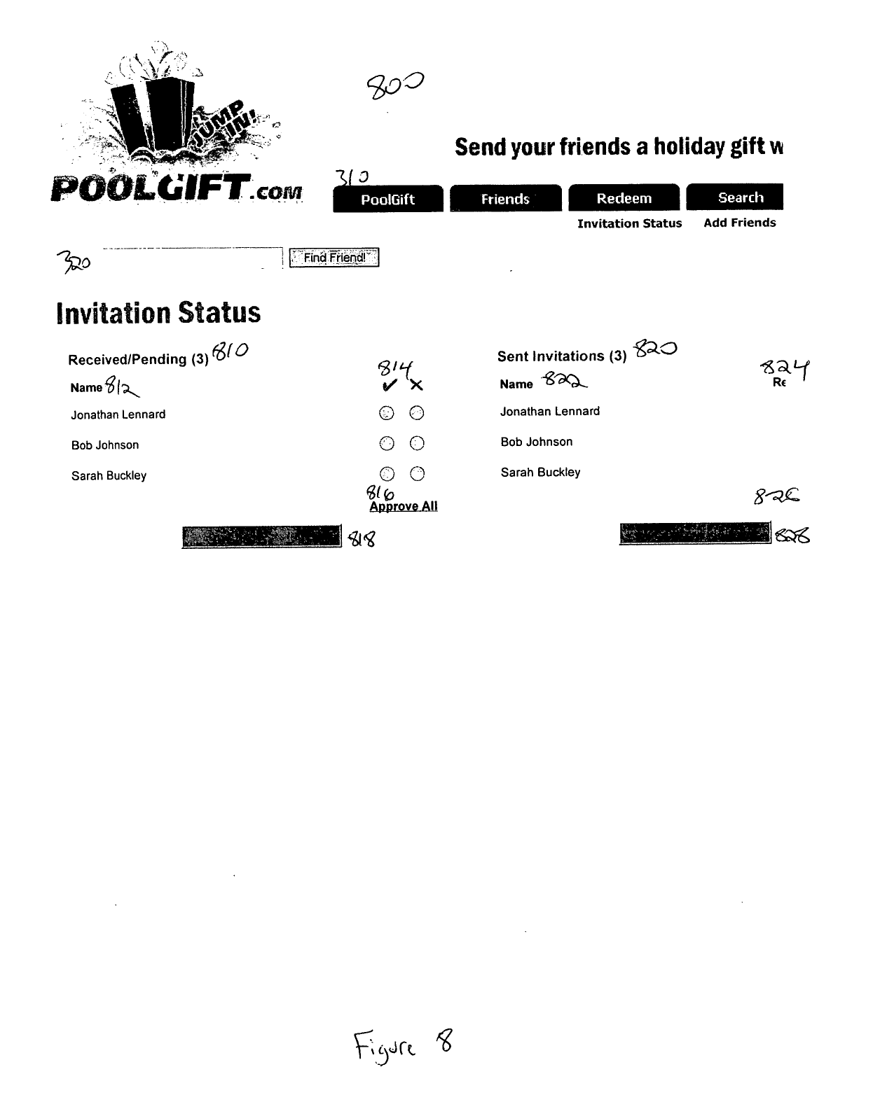

Referring to FIG. 8, invitation status page 800 is illustrated. In section 810, the status of received invitations is listed in table format with each invitation to become a friend of another user being listed on a separate row. The name of each user is listed in column 812 and accept/decline radio buttons are provided in column 814. All invitations can be accepted by clicking Approve all button 816 or the individual invitations accepted or declined can be executed by clicking on update invitations button 818. In section 820, sent invitations are listed listed in table format with each invitation to become a friend of the user being listed on a separate row. The name of each invited user is listed in column 822 and resend/withdraw radio buttons are provided in column 824. All invitations can be resent by clicking resend all button 826 or the individual invitations resent or withdrawn can be executed by clicking on resend/withdraw button 828.

Referring to FIG. 9, add friends page 900 is illustrated. In section 910, up to six persons can be invited to join as friends at one time. Each invited person is entered on one line of section 910, with such person's first name being entered in column 912, such person's last name being entered in column 914, and such person's e-mail address being entered in column 916. An invitation can be typed in text area 920, or the default invitation can be used. By clicking on button 930, e-mail invitations to each of the listed persons can be sent. Such invitations include directions and hyperlinks allowing the listed persons to register as users and friends of the inviting user.

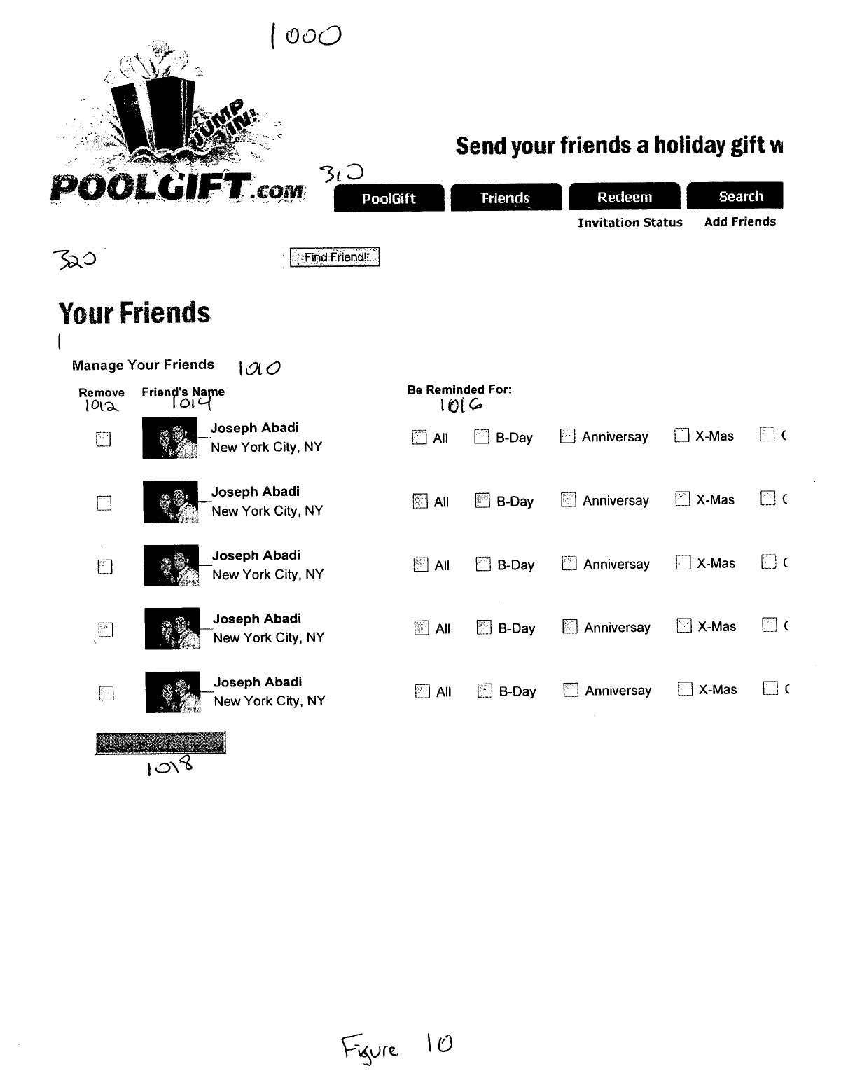

Referring to FIG. 10, manage your friends page 1000 is illustrated. In section 1010, the user's registered friends are listed in table format with each friend in a separate row. Check box 1012 allows the user to remove a friend from his circle of friends. Name 1014 lists the friend's name and location. Reminders checkboxes 1016 allow the user to elect to be reminded (so that he can consider commencing a group gift) whenever any one or more of the friend's birthday or anniversary occurs, at Christmas or Hannukah or at all of such times. In a first preferred embodiment, a group gift is automatically set up for the birthday of each friend. Button 1018 allows any changes to be updated.

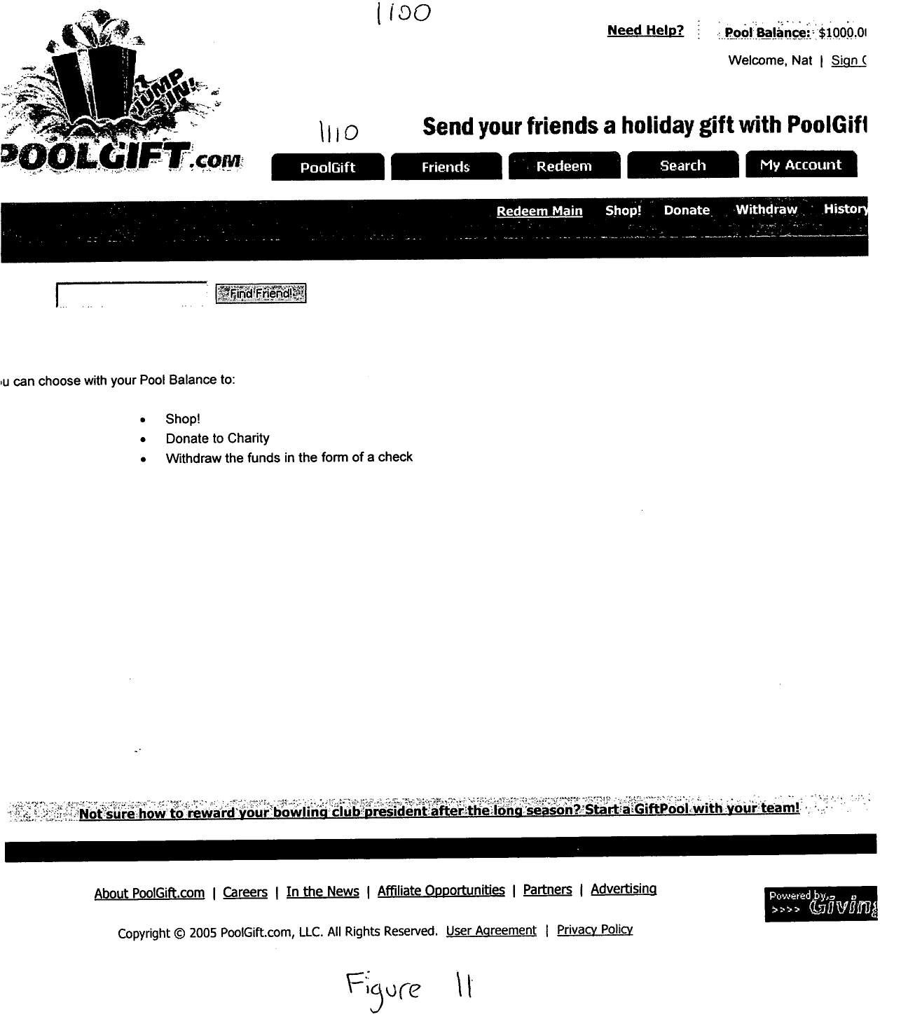

Referring to FIG. 11, redeem gifts page 1100 is illustrated. Redeem gifts page 1100 includes a series of hyperlinks 1110 to other pages. Hyperlinks 1110 allow a user to choose how to redeem the net proceeds of a gift that the user has received. In the first preferred embodiment, the user can choose to use the net proceeds to (i) shop, (ii) make a charitable donation, or (iii) receive a cash gift. A separate hyperlink is associated with each choice and directs the user to a different redemption page. (The user can also choose to receive the net proceeds in some combination of the above methods.)

If the user chooses to shop, the user is directed to a list of merchants and, in the first preferred embodiment, can redeem one or more gift certificates from one or more merchants. For example, a user receiving a gift of $125, might redeem a $100 gift certificate from a first merchant and a $25 gift certificate from a second merchant. In some embodiments, certain merchants are featured and are given preferential treatment, such as a higher or more visible listing. Merchants can be featured if they sell gift certificates to the operator of the pooled gift web site at preferential terms (such as greater discounts to face value than equivalent competitors), pay advertising placement fees, or for other reasons. After the user selects one or more gift certificates, the face value of the gift certificates is deducted from the face value of the proceeds of the gift that the user received. Any remaining value remains available for future redemption by the user and the gift certificates are ordered for delivery to the user.

In other embodiments of the present invention, the user can be given the option to (or required to) shop directly on a featured merchant's web site instead of receiving gift certificates, with the user's account with the featured merchant (or with the user's credit card) being credited with an amount chosen by the user up to the face amount of the proceeds of the gift. In such embodiments, it is desirable for the featured merchant (or the user's credit card company) to provide a rebate or credit to the operator of the pooled gift page providing web site.

The user can also choose to make a charitable donation. If the user does so, the user is directed to a separate web a listing of charitable organizations, allowing the user to enter the amount that the user desires to give to charity and the identity of the recipient charity or charities. The amount that the user can give to charity is limited to the net proceeds of the gift.

The can also choose to receive a cash gift. If the user does so, the user is directed to a separate web allowing the user to enter the amount that the user desires to receive (up to the net proceeds of the gift).

Referring to FIG. 12, search page 1200 is illustrated. In search area 1210, a person's name can be entered in text box 1212, the person's hometown can be entered in text box 1214, and the person's home state can be entered in drop down box 1216. By pressing button 1218, a user can search all registered users, whether or not currently friends of the user, for a possible match. In some embodiments of the present invention only perfect matches of the search terms are returned. In other embodiments, if no perfect matches exist, a variety of algorithms can be utilized to return partial or imperfect matches (e.g., same name and home state, but different home town, or same home town and home state and name differing only by one or two letters).

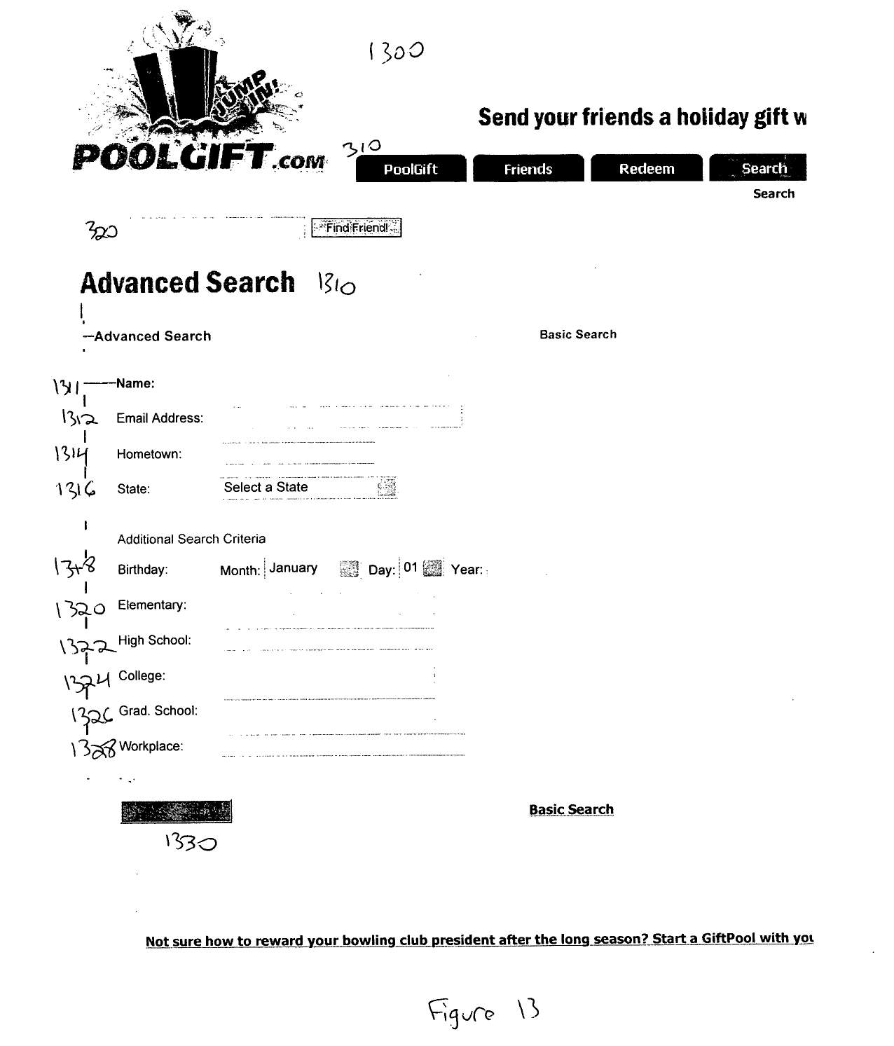

Referring to FIG. 13, advanced search page 1300 is illustrated. In search area 1310, a person's name can be entered in text box 1311, the person's e-mail address can be entered in text box 1312, the person's hometown can be entered in text box 1314, and the person's home state can be entered in drop down box 1316. Optionally, the person's birthday can be entered in area 1318, the person's elementary school can be entered in text box 1318, the person's high school can be entered in text box 1320, the person's college can be entered in text box 1322, the person's graduate school can be entered in text box 1324, and the person's workplace can be entered in text box 1328. By pressing button 1330, a user can search all registered users, whether or not currently friends of the user, for a possible match. In some embodiments of the present invention only perfect matches of the search terms are returned. In other embodiments, if no perfect matches exist, a variety of algorithms can be utilized to return partial or imperfect matches (e.g., same name and home state, but different home town, or same home town and home state and name differing only by one or two letters).

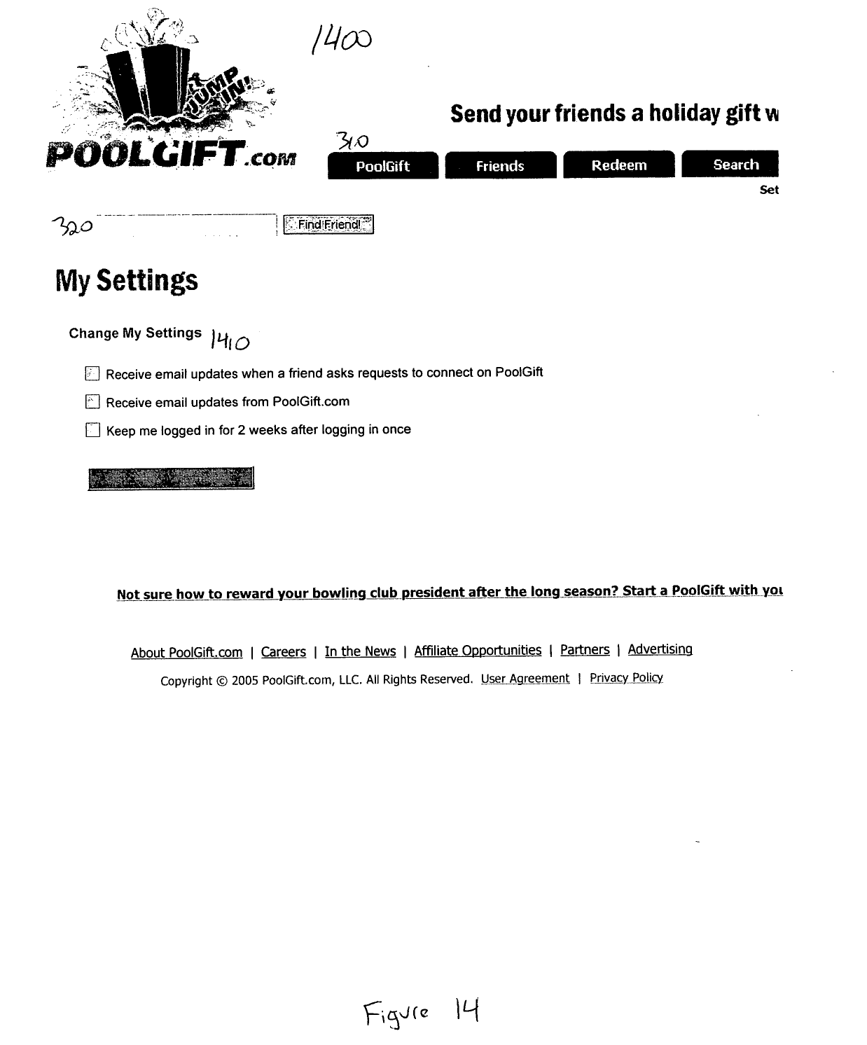

Referring to FIG. 14, settings page 1400 is illustrated. In settings area 1410 several settings relating to e-mail updates and remaining logged in are listed and can be changed by the user.

Referring to FIGS. 15A and 15B, account information page 1500 is illustrated. In optional account information area 1510, a user can supply a photograph, the user's hometown, the user's workplace, the user's elementary school and year of graduation, the user's high school and year of graduation, the user's college and year of graduation, the user's graduate school and year of graduation, a list of the user's interests, a favorite quote, and up to four additional e-mail addresses. In basic account information section 1520, the user must supply the user's name, address, telephone number, e-mail address, birthday, and password.

In other embodiments of the present invention web sites different than the one illustrated in FIGS. 3 through 15A and 15B can be utilized and non-web based software can be used to implement the present invention. Moreover, all of the details of the implementation of the present invention described in connection with such web site are merely one example of an implementation of the present invention and should not be considered to restrict the present invention in any respect. The present invention may be embodied in other specific forms without departing from the spirit or essential attributes of the invention. Accordingly, reference should be made to the appended claims, rather than the foregoing specification, as indicating the scope of the invention.

That which is claimed is:

1. A method for facilitating group gifts, comprising the steps of:
(a) Prompting a first user to provide registration information;
(b) Prompting the first user to prompt at least one additional user to provide registration information as a friend of the first user;
(c) Prompting any users that have provided registration information as friends of each other in response to steps (a) and (b) to identify a group gift;
(d) Prompting any users that have provided registration information as friends of each other in response to steps (a) and (b) to contribute to a group gift identified in response to step (c);
(e) Accumulating any contributions provided by any users in response to step (d) for the benefit of the recipient of the group gift; and
(f) Providing the proceeds of the group gift to the recipient thereof.

2. The method of claim 1, wherein step (b) comprises prompting the first user to prompt all persons known to the first user to share a particular interest to register as friends of the first user.

3. The method of claim 1, wherein step (b) comprises prompting the first user to prompt all personal friends of the first user to register as friends of the first user.

4. The method of claim 1, wherein step (b) comprises prompting the first user to prompt all persons known to the first user have attended the same educational institution to register as friends of the first user.

5. The method of claim 1, wherein step (b) comprises prompting each user registered as a friend of the first user to identify a specific group gift.

6. The method of claim 1, wherein step (b) comprises prompting each user registered as a friend of the first user to identify a class of recurring group gifts.

7. The method of claim 1, wherein step (b) comprises prompting each user registered as a friend of the first user to identify a class of non-recurring group gifts.

8. The method of claim 1, further comprising the step of:
(g) prompting at least one additional user identified by the first user in response to step (b) in turn to prompt at least one additional user to provide registration information.

9. The method of claim 1, wherein at least one additional user identified by the first user in response to step (b) is not prompted to prompt in turn at least one additional user to provide registration information.

10. The method of claim 1, wherein step (d) comprises suggesting a plurality of monetary contributions to the group gift.

11. The method of claim 1, wherein step (d) comprises providing a date by which all contributions to the group gift must be committed.

12. The method of claim 1, wherein step (d) comprises accepting credit card payments as fulfillment of monetary contributions to the group gift.

13. The method of claim 1, wherein step (c) comprises prompting at least one user to identify a recipient of a group gift.

14. The method of claim 1, wherein step (d) comprises prompting at least one user to identify the proposed value of a group gift.

15. The method of claim 1, wherein step (d) comprises prompting at least one user to identify the suggested merchandise comprising a group gift.

16. The method of claim 1, wherein step (d) comprises prompting at least one user to identify the date of the event to which a group gift relates.

17. The method of claim 1, wherein step (d) comprises prompting at least one user to identify the date by which contributions to a group gift must be committed.

18. The method of claim 1, wherein step (f) comprises providing merchandise purchased with the contributions of the users accumulated in step (e).

19. The method of claim 1, wherein step (f) comprises providing gift certificates equal to nominal value of the contributions of the users accumulated in step (e).

20. A system for facilitating group gifts, comprising:
a processor;
a memory connected to the processor; and
a plurality of remote terminals,
wherein a first user is prompted to provide registration information;
the first user is prompted to prompt at least one additional user to provide registration information as a friend of the first user;
any users that have provided registration information as friends of each other are prompted to identify a group gift;
any users that have provided registration information as friends of each other are prompted to contribute to a group gift;
any contributions provided by any users are accumulated for the benefit of the recipient of the group gift; and
the proceeds of the group gift are provided to the recipient thereof.
